(19) United States
(12) Patent Application Publication
(10) Pub. No.: US 2019/0287035 A1
(43) Pub. Date: Sep. 19, 2019

(54) OPTIMIZING CLIENT-INITIATED SEGMENT CREATION

(71) Applicant: JetSmarter Inc., Fort Lauderdale, FL (US)

(72) Inventors: Olga Oleyarsh, Fort Lauderdale, FL (US); Alexey Moshkov, Fort Lauderdale, FL (US)

(21) Appl. No.: 15/922,612

(22) Filed: Mar. 15, 2018

(51) Int. Cl. G06Q 10/02; G06F 3/0482; H04L 29/08

(52) U.S. Cl. CPC G06Q 10/025; H04L 67/12; G06F 3/0482

(57) ABSTRACT

Methods, systems, and apparatus, including computer programs encoded on a computer storage medium, for enabling creation of client-initiated segments. In one aspect, a method includes obtaining historical data about previous segments and accessing a set of rules for the candidate segment. A determination of a baseline amount is made based on the set of rules for the candidate segment and the historical data. The baseline amount is adjusted based on current factors including current availability of other segments having attributes matching the set of attributes of the candidate segment. An updated amount required for creation of the candidate segment is generated for each day within a specified period. Interaction with a client-initiated segment control corresponding to a particular route is detected. A user interface is updated to include the updated amount. The client-initiated segment is created based on submission of the updated amount required.

### BACKGROUND

This specification relates to optimizing client-initiated segment creation.

Historically, options for traveling between an origin and a destination have been limited to commercial public options in which individual spots (e.g., seats) are acquired by anyone and private options in which all spots in an aircraft or other mode of transport are acquired together by an individual.

### SUMMARY

In general, one innovative aspect of the subject matter described in this specification can be embodied in methods that include the actions of identifying a set of candidate segment attributes specifying, for each candidate segment among a plurality of different candidate segments, a set of segment attributes including a route of the candidate segment; for each candidate segment: obtaining, from a historical data storage unit, historical data about previous segments having attributes matching the set of attributes for the candidate segment; accessing, within a segment rules database, a set of rules for the candidate segment; determining, based on the set of rules for the candidate segment and the historical data about the previous segments, a baseline amount required for creation of the candidate segment; adjusting the baseline amount based on current factors including current availability of other segments having attributes matching the set of attributes of the candidate segment; generating, for each day within a specified period, an updated amount required for creation of the candidate segment; detecting interaction with a client-initiated segment control corresponding to a particular route at a client device executing an application; updating a user interface of the application to include the updated amount required for creation of a client-initiated segment along the particular route; creating the client-initiated segment based on submission of the updated amount required for creation of the client-initiated segment along the particular route.

These and other embodiments can each optionally include one or more of the following features. Methods can include logging, in the historical data storage unit, historical data for the particular segment including one or more of a total number of spots on the segment, a number of claimed spots on the segment, and a total amount submitted for the claimed spots; and updating the baseline amount required for creation of a future segment having attributes matching the set of attributes of the particular segment.

Methods can include determining that a segment change condition has been met for a given segment among the plurality of different candidate segments; in response to determining that the segment change condition has been met, creating one or more special segment entries, each having a lower amount required than the updated amount required.

Methods can include determining that a special segment end condition has been met; and deactivating the one or more special segment entries based on the determination that the special segment end condition has been met.

Determining that a special segment end condition has been met can include determining that a threshold number of segments have been created based on the one or more special segment entries; and deactivating the one or more special segment entries based on the determination that the special segment end condition has been met comprises deactivating the special segment entry when the threshold number of segments have been created.

Determining that the segment change condition has been met comprises determining that a different segment having a destination matching an origin of the given segment has been created by a different client and that a complementary segment to an origin of the different segment has not been created; and creating the one or more special segment entries comprises creating a given special segment entry for the complementary segment to the origin of the different segment.

Determining the baseline amount required can include determining a different baseline amount for each of two or more different client levels. Other embodiments of this aspect include corresponding systems, apparatus, and computer programs, configured to perform the actions of the methods, encoded on computer storage devices.

The subject matter described and claimed in this document can provide one or more of the following advantages. Various different clients are enabled to create new, not yet existing, segments in real-time. The segments can be created by the clients at any time utilizing a client side application (e.g., a native application executing at a client device). The details of many different segments on many different days are continually updated so that the client is provided the most up to date information about the segments, thereby enabling the real-time creation of the segments. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example environment in which client-initiated segments are created.

FIGS. 1B-1E are screen shots of an example application that enables creation of client-initiated segments.

FIG. 2 is a block diagram of an example data flow for determining an amount required to confirm a client created segment.

FIG. 3 is a flow chart of an example process for determining an amount required to confirm a client created segment.

FIG. 4 is a block diagram of an example computing device.

Like reference numbers and designations in the various drawings indicate like elements.

### DETAILED DESCRIPTION

This document describes methods, systems, devices and computer readable medium that facilitate creation of client-initiated segment. As used throughout this document, a segment refers to a flight between an origin and a destination. As discussed in detail below, the segment can be initiated by a client (e.g., a member of a service and/or a user of an application that facilitates creation of the segment), and made available to other clients, for example, by way of a native mobile application (or another appropriate interactive environment, such as a web interface). The aircraft used to travel between the origin and destination is typically a non-commercial aircraft (e.g., a private jet). While any appropriate type of aircraft (e.g., a propeller aircraft, a jet aircraft, or a rotorcraft) can be used to complete the segment, the various possible aircraft will be collectively referred to using the term “jet” for brevity.

As discussed in more detail below, the efficient creation of client-initiated segments requires a real-time interaction between the client that is initiating the segment and the automated computing system that is facilitating the creation of the client-initiated segment, which is also simply referred to herein as a segment for brevity. One of the aspects that is required to enable real-time creation of a segment by a client is the ability to determine the appropriate amount that the client will be required to submit (e.g., the price the client will pay) to complete creation of the segment. The amount required to be submitted by the client (also referred to as the “required amount”) can be, for example, a monetary price or another appropriate measure of value that must be provided in exchange for the creation/completion of the segment. However, the determination of required among depends on a number of continuously/periodically changing factors, which makes it very difficult to determine in real-time. For example, the entity determining the required amount can differ from the entities that will be supplying the jets, which means that jet availability and/or cost will be subject to third party input at some time after the segment is created (e.g., confirmed) by the client. Additionally, the required amount will vary based on various factors such as the number of available spots (e.g., seats) on other segments at the time the segment is being created and/or the number of other clients that are requesting segments for the same origin to the same destination. The required amount can also differ based on the location of the jet when the segment is scheduled to leave the origin, and that location can be uncertain. Given these challenges and the real-time interactivity required to facilitate the creation of the segment, a robust technique of determining the amount that will be required to complete creation of the segment is needed.

An example technique for determining the amount required to be submitted for creation of a segment is discussed in more detail throughout this document. However, the technique can generally be carried out by utilizing a set of attributes for the candidate segment and a set of rules that provide the required amount for the candidate segment in the context of the set of attributes. The required amounts can then be adjusted over time based on various factors so that the current required amount can be presented within a client-side application at any time that a client interacts with the client-side application, rather than requiring the client to wait for that information in response to a request. Furthermore, the required amount information can be provided in a calendar view so that the client can quickly compare the required amounts on various different days without having to submit separate different requests for information or navigating to multiple different user interface displays. Thus, the limited display space on client devices is effectively utilized to provide a client (e.g., private flight service member) with comparative information about segment scheduling within a single user interface display and without requiring the client to submit multiple different requests for information.

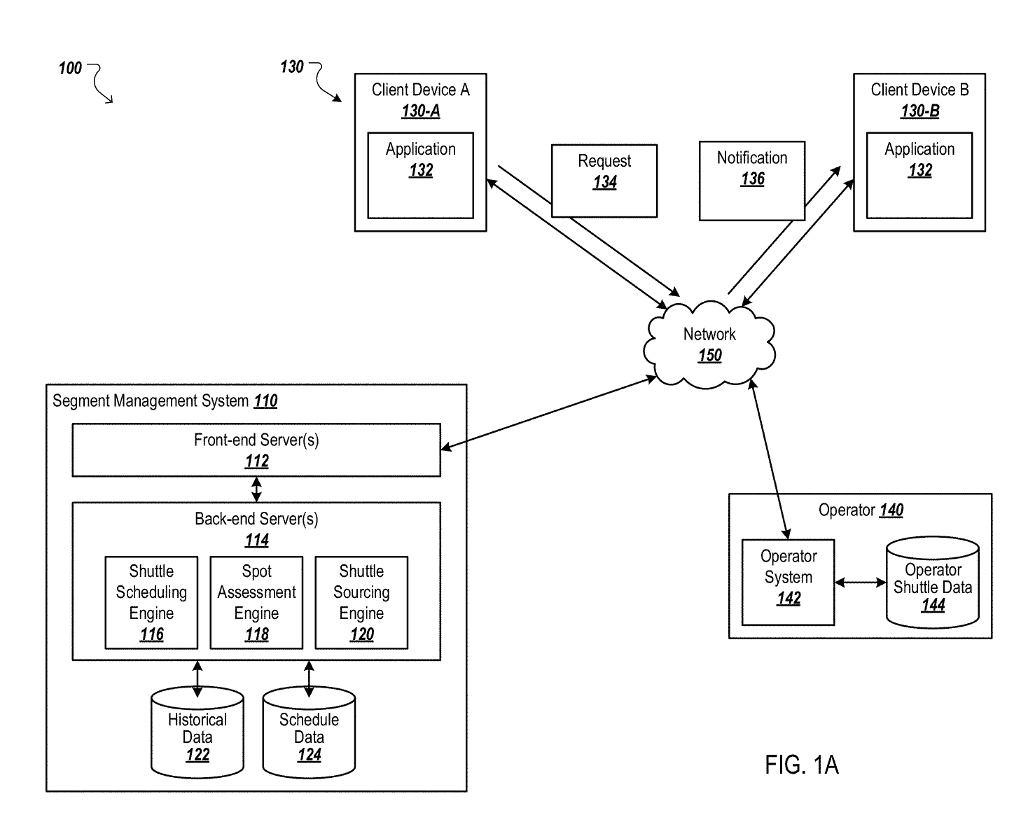

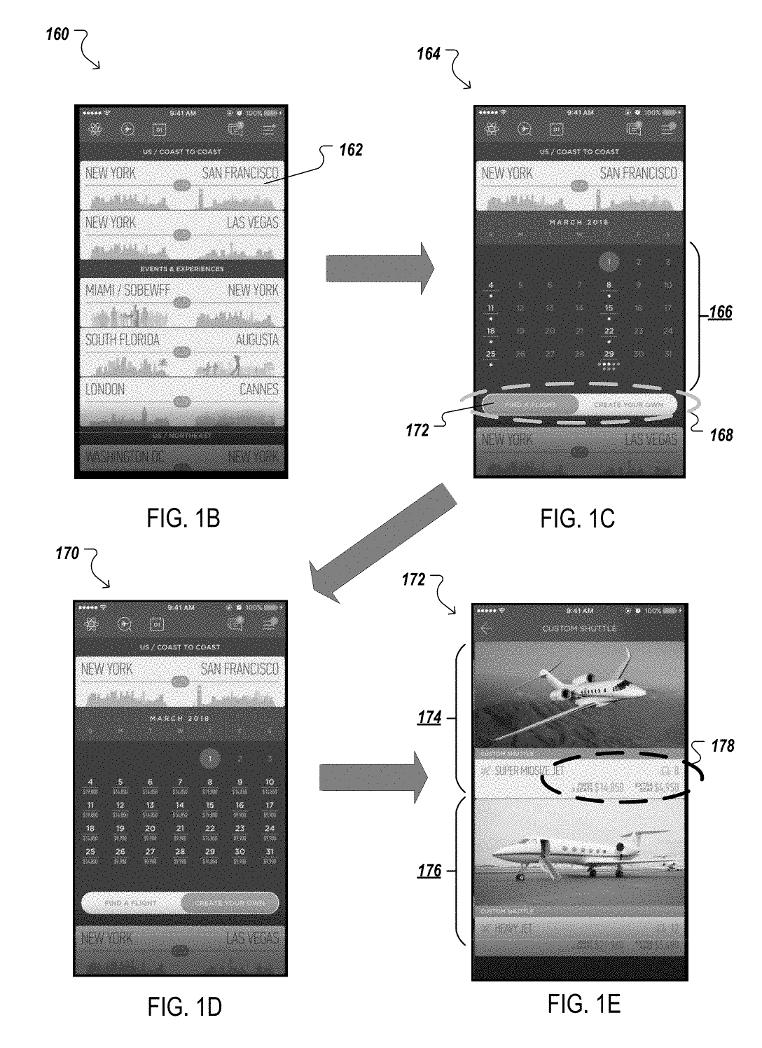

FIG. 1A is a block diagram of an example environment 100 in which a segment management system 110 enables clients to initiate segments. The example environment 100 includes a network 150, such as a local area network (LAN), a wide area network (WAN), the Internet, a mobile network, or a combination thereof. The network 150 connects client devices 130 (e.g., client device A 130-A and client device B 130-B) of clients, the segment management system 110, and operator systems 142 of operators 140. The example environment 100 may include many different client devices 130 and operators 140.

The segment management system 110, which can be operated and maintained by a service provider, allows users to arrange transportation on segments provided by the service provider. The service provider can provide scheduled segments (e.g., flights) between origins and destinations. The service provider can also allow clients (e.g., members of a service provided by the service provider) to initiate segments with custom attributes (e.g., custom departure date, origin, destination, and/or type of jet). For example, a client may want to travel from an origin to a destination on a day in which the scheduled segment(s) from the origin to the destination are full or on a day that no segments are scheduled from the origin to the destination. In this example, the client can initiate a segment from the origin to the destination on the day and/or time that the client wants to travel. A client that initiates a segment is also referred to as a creator.

A client can initiate and manage segments, claim a spot on a segment, manage other travel arrangements with the segment management system 110, and/or perform other appropriate tasks related to the segment management system 110 using a client-side application 132 executed on the client's client device 130. The application 132 can transmit data to, and receive data from, the segment management system 110 over the network 150. The application 132 can be implemented as a native application developed for a particular platform or a particular device, web browser that provides a web interface, or another appropriate type of application. The application 132 can be executed by each of the client devices 130A and 130B.

A client device 130 is an electronic device that is capable of requesting and receiving resources over the network 150. Example client devices 130 include personal computers, mobile communication devices, and other devices that can send and receive data over the network 150. A client device 130 typically includes a user application, such as a web browser or native application, to facilitate the sending and receiving of data over the network 150. The description that follows refers to a client device that interacts with the segment management system using a native application, but the description that follows is equally applicable to interactions with web pages and/or other web-based resources.

The client devices 130A and 130B can each execute the application that facilitates creation of client-initiated segments. In some implementations, as shown in FIG. 1B, the application can provide a user interface 160 that enables a client (e.g., application user or service member) to select a route for the segment. For example, the user interface can present pairs of available departure geographic locations (e.g., available origins) and available destination geographic locations (e.g., available destinations) for a segment, and the client can select a pair of geographic locations from the user interface. More specifically, with reference to FIG. 1B, the user interface 160 presents a route 162 that originates in New York and has a destination of San Francisco, as well as other routes between other geographic locations. The client can interact with a particular route between a pair of available geographic locations presented in the UI 160 to select that route for the segment. For example, the client can interact with (e.g., taps or clicks) the route 162 to select an origin of New York for the segment and a destination of San Francisco for the segment.

In response to selection of the particular route 162, the application can transition to another UI 164 that enables the client to specify a departure date and/or departure time for the segment over the selected route 162. For example, as shown in FIG. 1C, the UI 166 can present a calendar interface 166 that shows available dates for already scheduled segments between the particular geographic locations of the selected route 162. Note that other ways of presenting the available dates can be used (e.g., a list of available dates).

The calendar interface 164 includes segment creation interface control 168 that enables a client to transition from the user interface 164 that presents already scheduled segments to calendar interface 170, presented in FIG. 1D, which provides the client with information about creating a client-initiated segment over the selected route 162. A client can transition between the calendar interface 164 to the calendar interface 170 by interacting with a bar 172 within the segment creation interface control 168, which triggers the bar 172 to transition from one side to the other, and transitions the client application between the calendar interface 164 and the calendar interface 170 of FIG. 1D.

In some implementations, the calendar interface 170 specifies example amounts that must be submitted (e.g., minimum prices) to confirm a segment on the selected route 162 on different days. For example, the calendar interface 170 shows a minimum required amount of $19,800 for a segment on Mar. 8^{th}, and a minimum required amount of $14,850 for a segment on Mar. 9^{th}. Minimum required amounts are presented for each day of the month on which a client can create a segment. For example, as shown in FIG. 1D, minimum required amounts are presented for Mar. 4^{th}-Mar. 31^{st}, indicating to the client that the client can create a segment on any of these dates. Meanwhile, a minimum required amount is not presented for Mar. 1^{st}-Mar. 3^{rd}, indicating that the client cannot create a segment on those dates.

The amount required to be submitted in this example is expressed in terms of U.S. dollars, but the amount required to be submitted could be expressed in terms of other currencies or items of value, such as internal credits (e.g., renewable tokens or other forms of credits) that are issued by the service provider or some other entity. For example, the service provider may issue clients (e.g., members of a jet service) one or more tokens that can be used (e.g., alone or in combination with a specified amount of money) to secure one or more seats on a segment. When the segment has been completed (e.g., when the subscriber arrives at the destination), the token can be recredited to the subscriber (e.g., added back to the subscriber's account) for use toward another segment.

The segments for which required amounts are presented in the calendar interface are referred to as candidate segments because they are available for creation, but do not exist yet. The presentation of candidate segment information in this manner provides the client with an enhanced user interface that enables the user to quickly obtain access to the minimum required amounts required to create segments on various days without requiring the client to interact with each of the dates on the calendar to obtain the underlying candidate segment information related to that date. This presentation scheme saves the client time, provides direct access to more information, and improves the efficiency of providing relevant information to the client (e.g., by requiring fewer interactions to obtain the information and more efficiently using limited space in the user interface). The manner in which required amounts for candidate segments are determined will be discussed in more detail below.

To obtain more information about segment availability on a specific date, the client can tap or otherwise interact with that specific date in the calendar interface 170. Interaction with a specific date in the calendar interface can trigger the application being executed by the client device to transition from the calendar interface 170 to the segment detail interface 172. For example, if the client interacts with (e.g., taps) the calendar entry for Mar. 8^{th}, the application can present jet information elements 174 and 176, which are also referred to as jet info cards.

In this example, there are two types of jets available for the segment between New York and San Francisco on Mar. 8^{th}, and a respective jet info card is presented for each type of jet. If more than two types of jets are available for the candidate segment, more jet info cards could be presented in the segment detail interface 172 or the application could allow the creator to scroll down to view additional jet info cards.

Continuing with the present example, the jet info card 174 provides information about a candidate segment that can be created using a super midsize jet to travel along the selected route 162. The jet info card includes a representative image of a custom midsize jet (e.g., not an image of the actual jet that would be used for the segment) and segment details 178. The segment details 178 specify a number of spots (e.g., passenger seats) that are on the super midsize jet, the required amount to create the segment using the super midsize jet, and how many spots the client will obtain by submitting the required amount. In this example, the required amount of $14,850 will enable the creator to create the segment using the super midsize jet, and provide the creator with access to three seats, leaving the remaining five seats available for other clients. Of course, the creator could pay to obtain additional ones of the remaining seats, just as other members can, by submitting the “extra seat” amount displayed in the segment details 178 for each additional seat. Similar segment details are provided for the heavy jet in the jet info card 176.

When the creator interacts with either of the jet info cards 174 or 176, the application can proceed to guide the creator through the rest of the process of creating the segment. For example, the application can allow the creator to specify a departure time and/or other details regarding the segment, submit the required amount to create the segment, and confirm the creation of the segment. The segment confirmation is completed, for example, by the segment management system 110, of FIG. 1A.

The segment management system 110, in conjunction with the application 132, enables clients to initiate segments as discussed above, claim a spot (e.g., seat) on an existing segment, and/or perform other appropriate tasks. To facilitate these capabilities, the application 132 can transmit data to, and receive data from, the segment management system 110 over the network 150. The application 132 can be implemented as a native application developed for a particular platform or a particular device, web browser that provides a web interface, or another appropriate type of application. As discussed, the application 132 can present and detect user interactions with various interfaces that allow the client to initiate segments, manage segments, and/or claim a spot on segments.

The segment management system 110 includes one or more front-end servers 112 and one or more back-end servers 114. The front-end servers 112 can transmit data to, and receive data from, client devices 130, e.g., client device A 130-A and client device B 130-B, and operator systems 142 of operators 140 over the network 150. For example, the front-end servers 112 can provide, to the application 132 of a client's client device 130, interfaces or data for presentation with the interfaces. The front-end servers 112 can also receive data specifying user interactions with the interfaces of the application 130, such as attributes of a segment initiated by the client. As described in more detail below, the front-end servers 112 can update the interfaces, provide new interfaces, and/or update the data presented by the interfaces based on user interactions with the application 132.

The front-end servers 112 can also communicate with the back-end servers 114. For example, the front-end servers 112 can identify data that is to be processed by the back-end servers 114, e.g., data specifying attributes of a candidate segment, and provide the identified data to the back-end servers 114. The front-end servers 112 can also receive, from the back-end servers 114, data for a particular client and transmit the data to the client device 130 of the particular client over the network 150.

The back-end servers 114 include a segment scheduling engine 116, a spot assessment engine 118, and a segment sourcing engine 120. The segment scheduling engine 116 manages the creation, confirmation, and/or cancellation of segments including segments. The segment scheduling engine 116 can receive data specifying attributes of a segment initiated by a client and create the segment within the segment management system 110. For example, a client that uses client device A 130-A can interact with the application 132 to initiate a segment and specify attributes of the segment. The attributes can include a departure geographic identifier (e.g., an origin city or airport code), a destination geographic identifier (e.g., a destination city or airport code), a departure date (which can include a date and/or time) at which the segment will depart from the origin, a type of jet (e.g., light, midsize, heavy, propeller, rotorcraft, etc.), and/or other appropriate attributes. As used herein, the term engine refers to a data processing apparatus that performs a set of tasks.

The application 132 can generate a segment request 134 and cause the client device A 130-A to transmit the segment request 134 to the segment management system 110 over the network 150. The segment request 134 can include one or more of the client-specified attributes. In some implementations, the segment request 134 can include all of the attributes. For example, the application 132 can cause the client device A 130-A to transmit the segment request 134 after all of the appropriate attributes have been obtained from the client. As discussed above, the application 132 can prompt the client for the attributes using multiple interfaces.

In some implementations, the segment request 134 includes only a portion of the attributes (e.g., less than all of the attributes required by the segment service provider). For example, the segment scheduling engine 116 can cause the application 132 to prompt the client for additional attributes or other information based on initial attributes received in the segment request 134. In a particular example, the segment request 134 can include the departure geographic identifier, destination geographic identifier, and departure date. The segment scheduling engine 116 can receive these attributes, identify what types of jets are available for travel from the origin to the destination, and provide data specifying the available types of jets to the client device A 130-A for presentation by the application 132 to the client. The client can then select from the available types of jets and the application 132 can cause the client device A to transmit data specifying the selected type of jet to the segment management system 110.

The segment scheduling engine 116 can receive the data and create the appropriate segment within the segment management system 110 based on the data and the attributes received from the client device A 130-A. The segment scheduling engine 116 can also store the data for the created segment in a schedule data storage unit 124. The schedule data storage unit 124 can include one or more databases (or other appropriate data storage structures) stored in one or more non-transitory data storage media (e.g., hard drive(s), flash memory, etc.).

The segment data storage unit 124 can store data for each segment that is provided by the segment service provider. For example, the segment data storage unit 124 can store data for each scheduled and each client-initiated segment. The data for each segment can include the departure geographic identifier for the segment, the destination geographic identifier for the segment, the departure date for the segment, the type of jet and/or an identifier of the actual jet being used for the segment, an identifier for each client that has claimed a spot on the segment, and/or other appropriate segment data. The data for each segment can also include data specifying whether the segment is a client-initiated segment or a service provider scheduled segment.

The segment scheduling engine 116 can notify other clients of the created segment. In some implementations, clients can view the various segments from an origin to a destination. For example, the application 132 can present segments from an origin to a destination using a calendar interface (e.g., the calendar interface 164 of FIG. 1C). The calendar interface can include, for each date, zero or more segment indicators for each segment scheduled (or conditional) to travel from the origin to the destination on that date. For example, each segment indicator may be a dot under the date in the calendar, as shown in FIG. 1C. In this example, after the segment is created, a segment indicator will be presented under the departure date for the segment to represent the created segment. If a different client is viewing the calendar interface for flights from the same origin and to the same destination as the created segment, the client can see the dot for the created segment and interact with the dot or the date (e.g., by selecting the dot or the date) to view more information about the created segment and/or claim a spot on the created segment.

In some implementations, the segment scheduling engine 116 notifies clients using push segment notifications 136 (and/or through client navigation of the application, as discussed in more detail below). For example, the segment scheduling engine 116 may send messages (e.g., within the application 132, via text messaging, and/or via e-mail) to the clients to notify the clients of the created segment. The messages can include a link to an application page within the application 132 (or to a web page in a web interface) to claim a spot on the segment. In some implementations, the segment scheduling engine 116 sends the notifications 136 to clients that are likely to be interested in the created segment, e.g., based on previous segments on which the clients were passengers, preferred location information specified by the clients (e.g., in a client profile), and/or the geographic (e.g., GPS) location of the clients.

Data regarding previous segments that were created by clients and/or on which clients were passengers is stored in a historical data storage unit 122, e.g., as part of data regarding each previously operated segment. In some implementations, the stored data can include one or more of an identifier of the client that created the segment, the type of aircraft selected for the created segment, an amount submitted by the client to create the segment or obtain a spot, a departure date and/or time for the segment, the origin and destination of the segment, a number of available seats remaining on the created segment when created and/or at departure time, the operator that will provide the selected aircraft, and/or other information.

The segment management system 110 also includes a spot assessment engine 118. The spot assessment engine 118 can determine the required amount that must be submitted by a creator to create each candidate segment and/or the amount that other clients are required to submit for each spot that remains available on a segment after creation. The required amount that must be submitted by the creator and/or the amount required for each remaining spot can be based on various factors, such as the type of jet, the departure and destination geographic identifiers, the departure date, the duration of time between the time the segment is initiated and the departure date, the type of segment (e.g., conditional or confirmed), data stored in the historical data storage unit 122, and/or other appropriate factors.

As discussed above, the application 132 can present the required amount to create a segment and the amount for each remaining spot of an already created segment at the interfaces that enable the clients to initiate a segment and/or to claim a spot on a segment. For example, the application 132 can request current amounts for a candidate segment from the spot assessment engine 118 in response to a client interacting with the bar 172 within the segment creation interface control 168 of FIG. 1C. In another example, the application 132 can request the information before the client selection, e.g., when the client opens the application 132, when the client selects the same origin and destination as the candidate segment, or periodically. In this way, the latency in presenting the information can be reduced. In some implementations, the amount of data cached at the client-device can be reduced by providing the data when it is needed to populate the user interface.

The segment management system 110 also includes a segment sourcing engine 120. The segment sourcing engine 120 can interact with the operator systems 142 of the operators 140 to select jets for the segments and obtain information about the jets (e.g., number of spots on the jet, costs for particular segments, range, etc.). For example, when the segment scheduling engine 116 creates a segment (e.g., a confirmed segment), the segment sourcing engine 120 can interact with the operator systems 142 to identify a jet of the same type as the created segment that can be used for the segment. For example, the segment sourcing engine 120 can submit a request to each operator system 142 for a jet of the type of the created segment.

In response to receiving a request, the operator systems 142 can obtain data regarding available jets from their respective operator segment data storage units 144 and provide, to the segment sourcing engine 120 the information about any available jets that the operator 140 would be willing to operate for the created segment (e.g., number of spots on the jet, rates for particular segments, range, etc.). If multiple operators 140 have an available jet, the segment sourcing engine 120 can select a jet for the created segment based on the information provided by the operator systems 142.

In some implementations, the front-end servers 112 of the segment management system 110 communicate with the operators systems using application programming interfaces (APIs). The use of the APIs require computational power to communicate data. To reduce the amount of computational power used by the APIs, the segment management system 110 may identify a subset (e.g., less than all) of operators 140 for a particular segment and provide the request to only the operators in the subset. The segment management system 110 can identify the subset of operators based on the departure geographic identifier (e.g., identify operators that operate jets in the geographic area from which the segment will depart), previous segments provided by the operators (e.g., previously provided a jet for the same origin and destination), types of jets that the operator operates, and/or other appropriate criteria. In some implementations, communications with operators can be carried out using other communications means (e.g., phone). When the segment has been confirmed by the operator, the selected aircraft will be deployed to the origin at an appropriate time so that the selected aircraft will be available for any clients that have obtained spots (e.g., seats) on the created segment.

One of the challenges in facilitating the creation of client-initiated segments is the ability to be able to provide an on-demand required amount for the creation of the requested segment when the client interacts with the application 132. For example, when clients are provided an application 132 that enables the clients to create a custom segment on demand at any time that the client chooses, the system that is facilitating the creation of this requested segment must be able to provide the client with an accurate required amount at the time that the client is creating the requested segment. This is particularly difficult in the context of aircraft because of the fact that aircraft can move among various different geographic locations over time, such that at any given time it is difficult to know where a particular aircraft will be at a specific time in the future (e.g., at a time when the client wants to depart from a specific location).

Additionally, the required amount (e.g., required price) is dependent on a number of ever changing factors that must be continually be taken into consideration in order to continuously provide the real-time ability to create the requested segment. Furthermore, the amount of data that is required to be considered, and the fact that this data is ever changing, prevents a person (or even a team of people) from being able to continually make the required amount available to various clients for countless possible travel routes (e.g., between various combinations of origins and destinations). For example, in the amount of time it would take a person to determine a single required amount for a single travel route and single jet type, the combination of factors required to be considered would have changed many times over, thereby rendering the human created required amount outdated. Manual computation of the required amount would also prevent the real-time interactivity that is provided by the system described herein. Thus, the use of a computer system to implement the techniques described herein is not simply to improve an existing process, but rather the use of the computer system is required to provide capabilities described herein.

To facilitate the generation and updating of required amounts for various different possible routes, the backend server 114 includes a spot assessment apparatus 118. As discussed in more detail below, the spot assessment apparatus 118 processes various sets of candidate segment attributes for various combinations of different possible segment routes and aircrafts to obtain a required amount for each combination of different segment routes and aircraft. This required amount is continually (or periodically) updated over time to adjust for changing factors that affect the required amounts for different ones of the combinations so that at any given point in time, a client can be provided an accurate required amount in response to real-time interactions with the application 132 being executed at the client device 130.

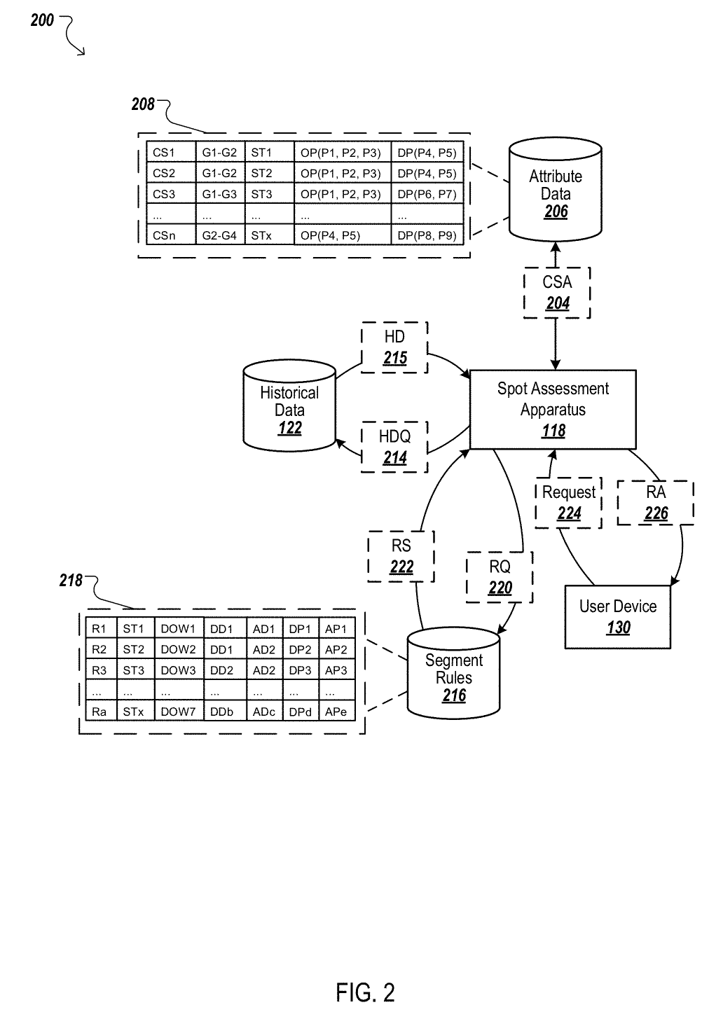

FIG. 2 is a block diagram of an example data flow 200 for optimizing client-initiated segment creation. The data flow 200 can begin with the spot assessment apparatus 118 obtaining a set of candidate segment attributes (CSA) 204. The CSA 204 can be obtained, for example, from an attributes data storage unit 206. The attributes data storage unit 206 can include a set of segment attributes for each candidate segment among multiple different candidate segments. For example, as shown in FIG. 2, the attributes data storage unit 206 can store an index of attributes 208 that are indexed to one or more possible routes, segment types (e.g., aircraft types), airport combinations, or other dimensions of data. In other words, the attributes data storage unit 206 can store a multi-dimensional index that can be searched based on any of the dimensions of data to obtain information about candidate segments having attributes that match specified search criteria. As used throughout this document, a candidate segment refers to a segment that is not currently scheduled, but can be created by a client.

The set of attributes stored in the attributes data storage unit 206 for each candidate segment can include, for example, a pair of geographic locations (e.g., G1-G2) between which the candidate segment will travel. For example, the notation G1-G2 in FIG. 2 indicates that an origin of the candidate segment CS1 is the geographic location G1 (e.g., a city/state combination) and the destination of CS1 is the geographic location G2. Similarly, the notation G1-G3 indicates that an origin of the candidate segment CS2 is the geographic location G1 and the destination of CS3 is the geographic location G3. Other pairs of geographic locations are similarly stored in the attributes data storage unit 206 for other candidate segments.

The set of attributes stored in the attributes data storage unit 206 can also include a segment type (e.g., ST1, ST2, STn) for each candidate segment. The segment type specifies a type of aircraft that is used for the candidate segment. For example, ST1 may specify that a light jet is being used for a candidate segment, while ST2 may specify that a super midsize jet will be used, and ST3 may specify that a heavy jet will be used. As shown in FIG. 2, the 208 indicates that ST1 will be used for CS1, while ST2 will be used for CS2. As such, different segment types are available between G1 and G2.

The set of attributes stored in the attributes data storage unit 206 can also include a set of available ports (e.g., airports) between which the candidate segment will travel. The set of available ports can include multiple different ports for each of the origin geographic location and the destination geographic location, as there are often multiple different airports at each geographic location. For example, the origin port (OP) for CS1 can be any of P1, P2, or P3 and the destination port (DP) for CS1 can be any of P4 or P5. These example attributes are only provided for purposes of illustration, and the attributes data storage unit 206 can certainly include various other attributes.

The spot assessment apparatus 118 obtains historical data 215 about each candidate segment. The historical data 215 can be obtained from the historical data storage unit 122. The historical data storage unit 122 is a data storage device that stores information about segments that have been previously completed. The historical data storage unit 122 can store information such as how many clients traveled on each prior segment (client total), departure and arrival dates for the segment, origin and destination information for the segment, and amounts submitted by the clients to travel on the segment.

The historical data 215 can be stored, for example, in a historical data index. The historical data index can be a multi-dimensional index in which various historical segment information can be obtained by searching any of the various dimensions of historical data. Thus, the spot assessment apparatus 118 can query the historical database can specify query terms corresponding to one or more of the dimensions of data stored in the historical data storage unit 122 to obtain historical information about a specific segment (or set of segments). More specifically, the historical data storage unit 122 can use the set of attributes (e.g., all or less than all of the attributes) to generate a historical data query (“HDQ”) 214 to obtain historical data 215 about the candidate segments. For example, the historical data storage unit 122 can generate a particular historical data query 214 that specifies one or more of the attributes of CS1 and query the historical data storage unit 122 using that historical data query 214. In this example, the historical data query 214 will return a set of historical data 215 for previous segments having attributes matching the set of attributes for the candidate segment CS1. Other queries can similarly be generated and used to obtain other sets of historical data for other candidate segments.

The spot assessment apparatus 118 accesses a segment rules data storage unit 216 to obtain a set of rules (“RS”) 222 for each candidate segment. The 216 is a data storage device that stores rules used to generate and/or update required amounts for different candidate segments. The rules can specify, for example, how to determine a baseline amount for each given candidate segment based on the set of attributes for the given candidate segment and/or the historical data for previous segments that have attributes matching the set of attributes for the given candidate segment. In some implementations, the rules stored in the 216 can be indexed to one or more segment attributes. For example, any of the rules can be indexed to attributes including one or more of a segment type (ST), a departure day of the week (DOW), a departure date (DD), an arrival date (AD), departure port (DP), arrival port (AP), and/or other appropriate attributes of a candidate segment. FIG. 2 includes an example illustration of a rules index 218 in which each rule is indexed to the attributes noted above. Rules can also be indexed to other attributes.

Indexing the rules to various different attributes enables efficient querying of the 216 to obtain a set of rules that are applicable to a particular candidate segment. In some implementations, the spot assessment apparatus 118 can generate a rule query (“RQ”) 220 that specifies a combination of attributes of the particular candidate segment, and can query the 216 to identify the set of rules 222 that are appropriate to apply to the particular candidate segment. For example, assume that the particular candidate segment is a segment between Atlanta and Fort Lauderdale, and the particular candidate segment will depart from Peachtree DeKalb Airport (PDK) in Atlanta, Ga. and arrive at Fort Lauderdale-Hollywood International Airport (FLL) in Fort Lauderdale, Fla. on a Wednesday. In this example, the rule query 220 generated by the spot assessment apparatus 118 can include the attributes of DP=PDK; AP=FLL; DOW=Wed. This rule query 220 will return the set of rules 222 that are indexed to the combination of attributes specified in the query, which can then be used by the spot assessment apparatus 118 to determine the baseline amount for the particular candidate segment.

In some implementations, the set of rules 222 for a particular candidate segment can specify how different ones of the attributes and/or historical data 215 contribute to the baseline amount for the particular candidate segment. For example, a particular rule set (e.g., R1) that is applied to a particular candidate segment (e.g., CS1) can specify that the amount of time between the creation date (e.g., when the segment is created) and the departure date will contribute a given amount to the baseline amount, and that the amount contributed increases as the amount of time between the creation date and the departure date decreases. Similarly, the set of rules 222 can specify different contributions to the baseline amount depending on the day of the week on which the departure date falls. For example, the set of rules 222 may specify that the contribution to the baseline amount for departure dates that fall on Mon-Thur. or Sat differ from the contribution to the baseline amount for departure dates that fall on Fri. or Sun. Similarly, the set of rules 222 can specify a contribution to the baseline based on an amount of time between the time at which the baseline amount is being determined and the date of departure. Generally, the contribution to the baseline amount increases as the amount of time between the time at which the baseline amount is being determined and the date of departure decreases.

In some situations, the different contribution amounts specified by the set of rules 222 can be determined, for example, based on application of the set of rules 222 to the historical data 215 obtained for the candidate segment. For example, the set of rules 222 can specify that the baseline amount be determined based on a combination of the average total amount received for past segments having the same attributes, the average cost of providing the past segments having the same attributes, and/or an average number of empty spots on the past segments having the same attributes. Of course, other historical measures for past segments can also be used to determine the baseline amount.

The creation of a new segment affects an overall availability of spots on segments having the same attributes (e.g., between the same DP and AP). For example, each time a new segment is created additional spots between the DP and AP are made available (assuming that the creator of the segment does not utilize all seats on the segment). As such, the set of rules 222 may specify an amount of contribution to the baseline amount (e.g., increase the baseline amount) for each additional positon (e.g., seat) that will be unoccupied at the time the segment is created (e.g., how many seats will be made available to other clients through creation of the candidate segment). Generally, the contribution amount for each additional spot will rise as the total number of available spots for that particular combination of DP and AP increases. In other words, as the total number of available spots for that particular DP and AP increases, the contribution to the baseline amount that is provided by each additional spot can increase.

The spot assessment apparatus 118 applies the set of rules 222 to the attributes of the candidate segment to determine the baseline amount for the candidate segment. The spot assessment apparatus 118 can determine a separate baseline amount for each different candidate segment that is able to be created by way of the application. The spot assessment apparatus 118 can adjust (and//or update) the baseline amount based on various conditions that may exist on a specific day and/or other factors that are unique to a given candidate segment. For example, the spot assessment apparatus 118 may determine that the historical data 215 indicates that a particular day of the year is a peak day for client segment creation (e.g., there may be increased demand for client-initiated segments on that particular day). In this example, the spot assessment apparatus 118 can apply a surge factor to the baseline amount for candidate segments on that particular day. The surge factor can be applied to the baseline amount, for example, by adding the surge factor to the baseline amount, multiplying the surge factor and the baseline amount, or otherwise increasing the baseline amount using the surge factor.

As noted above, there are a number of factors that change continuously (or at least periodically) over time. As such, the baseline amount (or adjusted baseline amount) that the spot assessment apparatus 118 determines for each candidate segment becomes stale very quickly. For example, each available segment spot (e.g., seat) that is claimed by another client or added by way of client creation of another segment affects the required amount for creation of another segment between the same DP and AP. Additionally, as time passes, the amount of time between the present time and a particular departure date for various candidate segments departing on that departure date decreases, which affects the amount that will be required to create the candidate segments having that departure date. As such, the spot assessment apparatus 118 can continually (or periodically) adjust and/or update the amount required for and/all of the candidate segments over time, and immediately make these adjusted amounts available through the application.

For example, after determining the baseline amount for a given candidate segment, the spot assessment apparatus 118 can access the historical data storage unit 122 and determine whether current factors (e.g., recently stored historical data) affect the baseline amount for the given candidate segment. Some of the current factors that affect the baseline amount for the given candidate segment include a change in a number of available spots on other segments that have one or more of the same attributes (e.g., route and/or date) as the given candidate segment, how many other segments have been created for the same route (e.g., DP to AP), and/or how many available segments having the same route as the candidate segment have expired.

In some implementations, the spot assessment apparatus 118 can adjust the baseline amount and/or a previously determined required amount obtained through a previous adjustment(s) to a baseline amount using one or more adjustment factors. For example, the spot assessment apparatus 118 can use a creator seat factor to adjust a required amount (e.g., a baseline amount or previously determined required amount) for a particular segment route (e.g., DP to AP pair and/or city pair). The creator seat factor can be used, for example, to increase the required amount for the particular candidate segment based on how many seats creation of a new segment will add to an inventory of available seats on that particular segment route. For example, the creator seat factor will generally be lower for a seven seat jet than a fifteen seat jet because creation of a new segment using the seven seat jet will add fewer seats the to the inventory of available seats than creation of a new segment using the fifteen seat jet.

The magnitude of the creator seat factor can also vary based on the current level of available seat inventory on the particular segment route. For example, the creator seat factor can increase as the total number of available seat inventory increases and decrease as the total number of available seat inventory decreases. As such, the creator seat factor can vary over time in proportion (e.g., linearly, logarithmically, or otherwise in proportion) to changes in the current level of available seat inventory. The spot assessment apparatus 118 can mathematically combine the creator seat factor with the current required amount in a variety of ways to adjust the required amount. For example, the creator seat factor can be added to or multiplied with a current required amount (e.g., the required amount just prior to the adjustment) to obtain an adjusted (or updated) required amount.

In some implementations, the spot assessment apparatus 118 can use a time penalty factor to adjust the baseline amount and/or a previously determined required amount obtained through a previous adjustment(s) to a baseline amount. A particular time penalty factor value can be applied, for example, on a per-route basis, on a per-city basis, on a per-region basis, or globally across all segment routes. The magnitude of the time penalty factor can vary over time. For example, the magnitude of the time penalty factor for a particular departure date can increase as the current time (e.g., the day on which the adjustment is being made) and the departure date decreases. In a specific example, assume that the current time is May 3, 2018 and a particular time penalty factor (e.g., for a specific route) for jets departing on May 10^{th} is X. In this example, on May 4^{th}, the particular penalty factor for jets departing on May 10^{th} can increase to X+Y based on amount of time between the current time and May 10^{th} decreasing by a day. In this example, the spot assessment apparatus 118 will use the time penalty factor X to determine the required amount on May 3^{rd}, and the spot assessment apparatus 118 will use the time penalty factor X+Y to determine the required amount on May 4^{th}. The time-based adjustment to the penalty factor can be a linear adjustment, a logarithmic adjustment, a schedule based adjustment, or another adjustment scheme.

In some situations, the service provider may allow for multiple different client levels, and the spot assessment apparatus 118 can generate multiple different required amounts for the same segment on a per-client-level basis. Clients may be able to attain different client levels in a variety of ways. For example, clients may be able to attain a higher client level by paying a fee, claiming a minimum number of seats on client-initiated segments over a given time period, referring a specified number of others that become clients, or engaging in some other appropriate activity. The service provider may provide incentives for clients to attain these higher client levels by varying the required amounts for segments based on client level. As such, the spot assessment apparatus 118 can generate multiple different required amounts for the same candidate segment by applying different client level factors. For example, the spot assessment apparatus 118 can generate a different required amount for each different client level by applying the client level factor for that client level to the required amount to create the per-client-level required amounts. Generally, the client level factor for higher client level will result in a lower required amount than the client level factor for a lower client level.

In some implementations, the spot assessment apparatus 118 can temporarily reduce the required amount for a particular segment route using a condition limited reduction factor. For example, when the spot assessment apparatus 118 determines that additional spots on a particular segment route need to be added to the current level of available inventory for that particular route, the 201 can apply the condition limited reduction factor to the required amount existing at the time of the determination to lower the required amount. The condition limited reduction factor is a value that is used to reduce the required amount until a particular condition is met. The condition can be, for example, the creation of a specified number of new client-initiated segments at the reduced required amount, a specified amount of time, the current available seat inventory meeting a specified level, or some other condition. When the particular condition has been met, the spot assessment apparatus 118 can disable the condition limited reduction factor for that particular segment route, and the spot assessment apparatus 118 can return to determining the required amount as discussed above without applying the condition limited reduction factor.

The spot assessment apparatus 118 can receive a segment request (“SR”) 224 from a user device 130, and reply to the request with a set of required amounts (“RA”) 226. The segment request 224 can include information specifying a particular segment route. The spot assessment apparatus 118 can use the particular segment route to select required amounts for that particular route, and return those required amounts in the set of required amounts 226. In some implementations, the spot assessment apparatus 118 will select required amounts for a specified time period. For example, when a calendar interface as described above with reference to FIG. 1D is used to present the required amounts, the spot assessment apparatus 118 can select the required amounts for the segment on each remaining day of the month on which a client can create the segment. In some situations, the spot assessment apparatus 118 can provide additional required amounts in the set of required amounts 226 in order to reduce the latency in presenting additional required amounts (e.g., if the client transitions to the following month in the application). In some situations, the spot assessment apparatus 118 can wait to provide those additional required amounts in response to a subsequent segment request, which can be triggered, for example, by the client transitioning to the next month in the application.

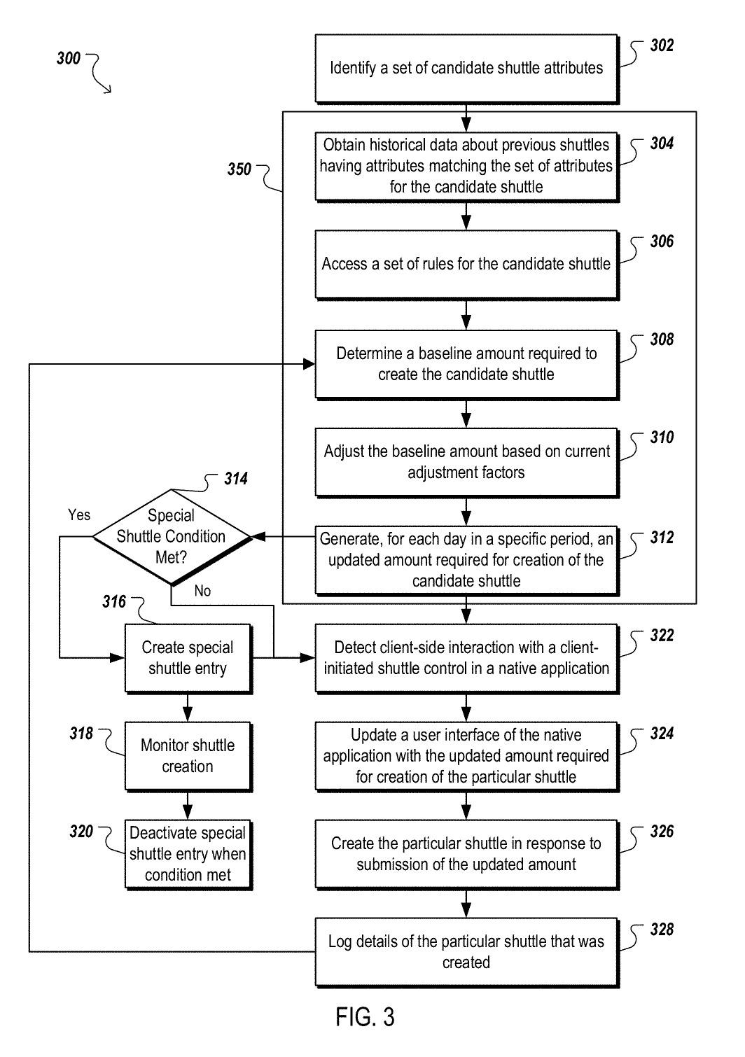

FIG. 3 is a flow chart of an example process 300 for optimizing client-initiated segment creation. Operations of the process 300 can be implemented by one or more servers (or other computing devices), such as the third-party content distribution system 110 of FIG. 1. Operations of the process 300 can also be implemented as instructions stored on a non-transitory computer readable medium, where execution of the instructions by one or more servers (or other computing devices or data processing apparatus) cause the one or more servers to perform operations of the process 300.

A set of candidate segment attributes are identified for various candidate segments (302). In some implementations, the set of candidate segment attributes are received in the form of data packets that include data specifying a route for the segment. For example, the candidate segment attributes can specify that the candidate segment will operate between San Francisco and New York. Other attributes can be included in the set of segment attributes. For example, the attributes can include any of a departure geographic identifier (e.g., an origin city or airport code), a destination geographic identifier (e.g., a destination city or airport code), a departure date (which can include a date and/or time) at which the segment will depart from the origin, and a type of jet (e.g., light, midsize, heavy, propeller, rotorcraft, etc.), and/or other appropriate attributes. The set of attributes can be identified in (or obtained from) the attributes data storage unit, as discussed above with reference to FIG. 2.

The operations 304-312 discussed below, which are included in the box 350, can be completed for each of the various candidate segments. However, the description that follows will refer to a single candidate segment for clarity.

Historical data about previous segments having attributes matching the candidate segment are obtained (304). The historical data specify, for example, one or more of a number of occupied spots on a segment, a total amount submitted by clients for the occupied spots, an operator that provided the aircraft for the segment, when the segment was created, whether the segment was client-initiated or created by the service provider, and/or other appropriate information. In some implementations, the historical data is obtained from the historical data storage unit, as discussed above with reference to FIG. 2.

A set of rules for the candidate segment are accessed (306). In some implementations, the set of rules are accessed from a segment rules storage unit, as discussed above with reference to FIG. 2. The rules can specify, for example, how various information is combined to determine the baseline required amount for the candidate segment and/or how various factors can be used to adjust the baseline required amount over time. For example, the rules for a particular candidate segment can specify that the baseline required amount can initially be set based on a historical average (or some other statistical measure) of the required amounts for previous segments having attributes matching those of the candidate segment. In this example, the rules can also specify that the initial baseline required amount can be adjusted based on current factors, such as a current level of inventory on other segments having the same route as the candidate segment among other factors. The rules can also specify how changes in the current factors over time will affect the required amounts over time. Example adjustments are discussed above with reference to FIG. 2.

A baseline amount required to create the candidate segment is determined (308). In some implementations, the baseline amount is determined by applying the set of rules to the historical data about the previous segments, as discussed above and with reference to FIG. 2. The baseline amount can be determined, for example, by the spot assessment apparatus 118.

The baseline amount is adjusted based on current adjustment factors (310). In some implementations, the current factors used to adjust the baseline amount include the current available of other segments having attributes matching the attributes of the candidate segment. For example, as discussed above, the baseline amount will generally be increased by an amount that is inversely proportional to the number of spots available on other segments between the origin and destination of the candidate segment. Additional adjustments can also be made, for example, as discussed above with reference to FIG. 2.

An updated amount required for creation of the candidate segment is generated (312). In some implementations, the updated amount required is generated for each day in a specific period of time. The updated amount can be based, for example, on an amount of time between the time at which the adjustment is being made and the departure date of the candidate segment. For example, the time penalty factor can be used to adjust the required amount for each day, as discussed above with reference to FIG. 2. Additionally, the required amount can be updated based on seasonality information. For example, the seasonality information may specify that a particular day is a peak day for client-initiated segments, and increase the required amount for that day.

In some implementations, a determination is made whether a special segment condition has been met (314). A special segment condition is a condition indicating that the required amount for the candidate segment should be decreased. The special segment condition can be met, for example, based on a number of available spots on other segments between the same route as the candidate segment being below a specified amount, a complementary segment being created by another client, or another event indicating that the required amount for the candidate segment should be reduced.

In some implementations, the special segment condition is met when fewer than a specified number of spots are available on other client-initiated segments (or other segments) on the same route as the candidate segment. For example, assume that the number of spots available between San Francisco (“SF”) and New York (“NY”) on a given day is less than the amount specified by the special segment condition. In this example, the special segment condition for segments between SF and NY on that given day will be met, and a condition limited reduction factor can be applied to the required amount for this candidate segment to reduce the required amount for this candidate segment.

Generally, the lack of available spots on client-initiated segments (or the lack of other client-initiated segments) for a specific route on a specific day is an indication that a client-initiated segment should be created for that specific route on that given day. To incentivize a client to create the segment for that route, the condition limited reduction factor is used to reduce the required amount for the creation of a client-initiated segment on that specific route and on that given day. The condition limited reduction factor is used while the condition exists, and can cease to be used once the condition no longer exists, as discussed in more detail below.

In some implementations, the special segment condition is met when a complementary segment to the candidate segment (referred to as a “complementary segment”) is created by another client, without a return segment being created. A complementary segment is a segment having a destination that matches an origin of the candidate segment and an origin that matches the destination of the candidate segment. Continuing with the example above, a segment from NY to SF is the complementary segment to the candidate SF to NY segment. Thus, when a client creates a segment from NY to SF, and does not also create a return segment from SF to NY, the special segment condition can be met for the candidate SF to NY segment. In some implementations, the special segment condition will be met for any SF to NY segment having a departure date that is within a given amount of time (e.g., 1 day, 2, days, or some other amount of time) following the arrival of the complementary segment in NY, but will not be met for other SF to NY segments that are outside of the given amount of time.

When it is determined that the special segment condition has been met, a special segment entry is created for the candidate segment (316). A special segment entry can be created by adjusting the required amount of a particular segment using the condition limited reduction factor to reduce the required amount. In some implementations, creation of the special segment entry also includes designating the candidate segment as a special segment. The candidate segment can be designated as a special segment, for example, by setting a special segment flag in data corresponding to the candidate segment or applying a special segment label to the candidate segment. The designation of the candidate segment as a special segment can also cause the candidate segment to be designated as a special segment (or “deal”) when the candidate segment is presented to a client in the application. The designation of the candidate segment as a special segment can also trigger distribution of a push message to one or more clients informing the clients of the special segment designation.

Segment creations are monitored (318). In some implementations, the monitoring of segment creation includes monitoring segments that are created along the same route as the special segment. The number of segments created along the same route, days of departure for those created segments, and/or other appropriate information.

The special segment entry is deactivated when an end condition is met (320). The end condition is a condition indicating that the special segment status should be removed from the candidate segment. In some implementations, the status of the special segment entry can be changed in response to the occurrence of one or more events. For example, the special segment designation can be removed, thereby reverting the candidate segment to a normal segment status when the one or more events meet the end condition.

The end condition can be met, for example, based on a threshold number of segments (e.g., one or more segments) being created by clients based on the special segment entry. For example, if a client creates a segment using the special segment entry (e.g., the required amount specified for the special segment) and the threshold number of segments is 1, the end condition can be determined to be met. In this example, the special segment entry can be deactivated based on the threshold number. Deactivating the segment entry prevents additional clients from utilizing the special segment entry to create additional segments.

In some implementations, the end condition can be met, for example, at a specified time. The specified time can be a given amount of time following the creation of the special segment entry. For example, the specified amount of time can be 1 day, 2 days, or some other specified amount of time following creation of the special segment entry. The specified amount of time could be a given amount of time prior to the departure date of the segment. For example, the end condition could be 2 days, 1, week, or some other amount of time prior to the departure date of the segment.

The operations 314-320 can be performed in parallel with (or independently of) the operations 322-328, discussed below. In some implementations, the operations 314-320 are optional.

Client-side interaction with a segment creation interface control of a native application is detected (322). In some implementations, the segment creation interface control corresponds to a particular route. For example, as discussed above with reference to FIG. 1C, the segment creation interface control can be presented in the application with a calendar interface for a particular route. As discussed above, the client can interact with segment creation interface control to request information about creating a segment along the particular route. In some implementations, the interaction with the segment creation interface control triggers submission of a request for information about the particular route to the segment management system 110 of FIG. 1A.

A user interface of the native application is updated with the updated amount required for creation of a client-initiated segment along the particular route (324). For example, as discussed above with reference to FIG. 1C, the user interface of the native application can be updated to present a calendar interface including required amounts for creation of a client-initiated segment on various days of the month.

The particular segment is created in response to submission of the updated amount required for creation of the client-initiated segment along the particular route. In some implementations, the submission of the required amount can be completed through interaction with the application at the client device. For example, the client can navigate through a creation workflow, and ultimately interact with a segment confirmation control. Interaction with the segment confirmation control can trigger submission of the required amount by the client.

Details of the particular segment are logged (328). In some implementations, the historical data storage unit are logged (e.g., stored) in the historical data storage unit described above with reference to FIG. 2 above. The logged data for each segment can include one or more of a total number of spots on the segment, a number of claimed spots on the segment, a total amount submitted for the claimed spots, a departure date/time of the segment, an arrival date/time of the segment, an arrival port, a departure port, an aircraft type, an operator that provided the aircraft, an amount submitted to the operator for use of the aircraft and/or any other appropriate information.

The baseline amount required to create the candidate segment can be updated based on the updated historical data that includes the logged details for the particular segment (308). In some implementations, updating the baseline price includes computing the updated baseline price based on the updated historical information that was logged in the historical data storage unit.

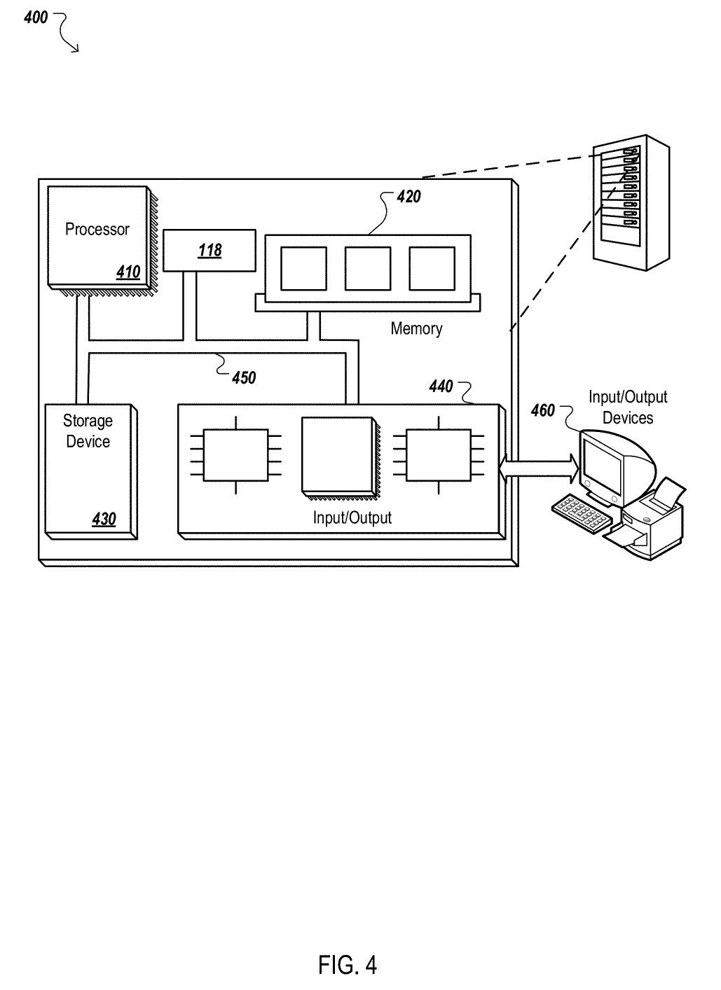

FIG. 4 is block diagram of an example computer system 400 that can be used to perform operations described above. The system 400 includes a processor 410, a memory 420, a storage device 430, an input/output device 440, and 118 as described in detail with reference to FIG. 1. Each of the components 118, 410, 420, 430, and 440 can be interconnected, for example, using a system bus 450. The 118 is shown as connected to 410, 420, 430, and 44, but could also be implemented across two or more of these components.

The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML, page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for enabling client-initiated segment creation, comprising:
one or more front-end servers that interact, over a data communication network with a native application operating at a client device; and
one or more back-end servers in data communication with the one or more front-end servers and that include one or more data processors, the one or more front-end servers or the one or more back-end servers being configured to perform operations comprising:
identifying a set of candidate segment attributes specifying, for each candidate segment among a plurality of different candidate segments, a set of segment attributes including a route of the candidate segment;
for each candidate segment:
obtaining, from a historical data storage unit, historical data about previous segments having attributes matching the set of attributes for the candidate segment;
accessing, within a segment rules database, a set of rules for the candidate segment;
determining, based on the set of rules for the candidate segment and the historical data about the previous segments, a baseline amount required for creation of the candidate segment;
adjusting the baseline amount based on current factors including current availability of other segments having attributes matching the set of attributes of the candidate segment;
generating, for each day within a specified period, an updated amount required for creation of the candidate segment;
detecting interaction with a client-initiated segment control corresponding to a particular route at a client device executing an application;
updating a user interface of the application to include the updated amount required for creation of a client-initiated segment along the particular route;
creating the client-initiated segment based on submission of the updated amount required for creation of the client-initiated segment along the particular route.

2. The system of claim 1, wherein the operations comprise:
logging, in the historical data storage unit, historical data for the particular segment including one or more of a total number of spots on the segment, a number of claimed spots on the segment, and a total amount submitted for the claimed spots; and
updating the baseline amount required for creation of a future segment having attributes matching the set of attributes of the particular segment.

3. The system of claim 1, wherein the operations comprise:
determining that a segment change condition has been met for a given segment among the plurality of different candidate segments;
in response to determining that the segment change condition has been met, creating one or more special segment entries, each having a lower amount required than the updated amount required.

4. The system of claim 3, wherein the operations comprise:
determining that a special segment end condition has been met; and
deactivating the one or more special segment entries based on the determination that the special segment end condition has been met.

5. The system of claim 4, wherein:
determining that a special segment end condition has been met comprises determining that a threshold number of segments have been created based on the one or more special segment entries; and
deactivating the one or more special segment entries based on the determination that the special segment end condition has been met comprises deactivating the special segment entry when the threshold number of segments have been created.

6. The system of claim 3, wherein:
determining that the segment change condition has been met comprises determining that a different segment having a destination matching an origin of the given segment has been created by a different client and that a complementary segment to an origin of the different segment has not been created; and
creating the one or more special segment entries comprises creating a given special segment entry for the complementary segment to the origin of the different segment.

7. The system of claim 1, wherein determining the baseline amount required comprises determining a different baseline amount for each of two or more different client levels.

8. A method for enabling client-initiated segment creation comprising:
identifying a set of candidate segment attributes specifying, for each candidate segment among a plurality of different candidate segments, a set of segment attributes including a route of the candidate segment;
for each candidate segment:
obtaining, from a historical data storage unit, historical data about previous segments having attributes matching the set of attributes for the candidate segment;
accessing, within a segment rules database, a set of rules for the candidate segment;
determining, based on the set of rules for the candidate segment and the historical data about the previous segments, a baseline amount required for creation of the candidate segment;
adjusting the baseline amount based on current factors including current availability of other segments having attributes matching the set of attributes of the candidate segment;
generating, for each day within a specified period, an updated amount required for creation of the candidate segment;
detecting interaction with a client-initiated segment control corresponding to a particular route at a client device executing an application;
updating a user interface of the application to include the updated amount required for creation of a client-initiated segment along the particular route;
creating the client-initiated segment based on submission of the updated amount required for creation of the client-initiated segment along the particular route.

9. The method of claim 8, comprising:
logging, in the historical data storage unit, historical data for the particular segment including one or more of a total number of spots on the segment, a number of claimed spots on the segment, and a total amount submitted for the claimed spots; and
updating the baseline amount required for creation of a future segment having attributes matching the set of attributes of the particular segment.

10. The method of claim 8, comprising:
determining that a segment change condition has been met for a given segment among the plurality of different candidate segments;
in response to determining that the segment change condition has been met, creating one or more special segment entries, each having a lower amount required than the updated amount required.

11. The method of claim 10, comprising:
determining that a special segment end condition has been met; and
deactivating the one or more special segment entries based on the determination that the special segment end condition has been met.

12. The method of claim 11, wherein:
determining that a special segment end condition has been met comprises determining that a threshold number of segments have been created based on the one or more special segment entries; and
deactivating the one or more special segment entries based on the determination that the special segment end condition has been met comprises deactivating the special segment entry when the threshold number of segments have been created.

13. The method of claim 10, wherein:
determining that the segment change condition has been met comprises determining that a different segment having a destination matching an origin of the given segment has been created by a different client and that a complementary segment to an origin of the different segment has not been created; and
creating the one or more special segment entries comprises creating a given special segment entry for the complementary segment to the origin of the different segment.

14. The method of claim 8, wherein determining the baseline amount required comprises determining a different baseline amount for each of two or more different client levels.

15. A non-transitory computer storage medium encoded with a computer program, the program comprising instructions that when executed by data processing apparatus cause the data processing apparatus to perform operations comprising:
identifying a set of candidate segment attributes specifying, for each candidate segment among a plurality of different candidate segments, a set of segment attributes including a route of the candidate segment;
for each candidate segment:
obtaining, from a historical data storage unit, historical data about previous segments having attributes matching the set of attributes for the candidate segment;
accessing, within a segment rules database, a set of rules for the candidate segment;
determining, based on the set of rules for the candidate segment and the historical data about the previous segments, a baseline amount required for creation of the candidate segment;
adjusting the baseline amount based on current factors including current availability of other segments having attributes matching the set of attributes of the candidate segment;
generating, for each day within a specified period, an updated amount required for creation of the candidate segment;
detecting interaction with a client-initiated segment control corresponding to a particular route at a client device executing an application;
updating a user interface of the application to include the updated amount required for creation of a client-initiated segment along the particular route;
creating the client-initiated segment based on submission of the updated amount required for creation of the client-initiated segment along the particular route.

16. The computer storage medium of claim 15, wherein the operations comprise:
logging, in the historical data storage unit, historical data for the particular segment including one or more of a total number of spots on the segment, a number of claimed spots on the segment, and a total amount submitted for the claimed spots; and
updating the baseline amount required for creation of a future segment having attributes matching the set of attributes of the particular segment.

17. The computer storage medium of claim 15, wherein the operations comprise:
determining that a segment change condition has been met for a given segment among the plurality of different candidate segments;
in response to determining that the segment change condition has been met, creating one or more special segment entries, each having a lower amount required than the updated amount required.

18. The computer storage medium of claim 17, wherein the operations comprise:
determining that a special segment end condition has been met; and
deactivating the one or more special segment entries based on the determination that the special segment end condition has been met.

19. The computer storage medium of claim 18, wherein:
determining that a special segment end condition has been met comprises determining that a threshold number of segments have been created based on the one or more special segment entries; and
deactivating the one or more special segment entries based on the determination that the special segment end condition has been met comprises deactivating the special segment entry when the threshold number of segments have been created.

20. The computer storage medium of claim 17, wherein:
determining that the segment change condition has been met comprises determining that a different segment having a destination matching an origin of the given segment has been created by a different client and that a complementary segment to an origin of the different segment has not been created; and
creating the one or more special segment entries comprises creating a given special segment entry for the complementary segment to the origin of the different segment.
